(19) United States
(12) Patent Application Publication
(10) Pub. No.: US 2007/0032244 A1
(43) Pub. Date: Feb. 8, 2007

(54) Group-centric location tagging for mobile devices

(75) Inventors: Scott J. Counts, Seattle, WA (US); Jordan L. K. Schwartz, Seattle, WA (US); Shelly D. Farnham, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/199,025

(22) Filed: Aug. 8, 2005

(51) Int. Cl. H04Q 7/20

(52) U.S. Cl. 455/456.1

(57) ABSTRACT

An annotation is manually and/or automatically correlated with a location and selectively distributed to participants of an associated user network. Thus, network participants possessing a common bond can obtain “trusted” information regarding specific locations. This allows a network participant to locate resources such as friends, restaurants, hotels, and/or entertainment sites, etc. based on the annotations provided by other network participants for those locations. Network users can annotate locations with temporal information, text, audio/video, photos, and/or graphics, etc. The annotations can be provided to the network via mobile devices and/or via non-mobile devices. Annotation information can be entered before a user visits a location, while a user is visiting a particular location, and/or after a user has visited a location. Location coordinates can be automatically provided and/or manually entered. Annotations are correlated with locations and made selectively available to network participants. Annotation retrieval can occur automatically and/or manually by participants.

### BACKGROUND

Mobile phones have revolutionized the ease in which people can communicate and socialize. They have become an integral part of society's social fabric, providing a connectedness that friends and family share with one another, allowing them to keep in touch, regardless of location. While voice communication is highly natural and expressive, it also requires immediate attention, occasional-privacy, quiet surroundings, and does not scale well for coordinating within medium and/or large groups of people. Traditional telephone voice-type services typically allow two parties to easily communicate and some services may allow a third party to join into the conversation. But if a group of 10 to 20 people wanted to coordinate an event, such as dining out for the evening, traditional services would generally require each participant to be called separately.

Text messaging, also know as SMS (Short Message Service), is a simple text communication tool for mobile phones. As the name implies, messages are very short, limited to 160 characters for most encoding schemes. SMS allows one person with an SMS-enabled phone to send a text message to another person with an SMS-enabled phone. Some phones have predetermined messages that save the user time by having the user select a response rather than type the text into the phone using the keypad numbers. SMS-enabled phones are in use worldwide, and the service is slowly gaining acceptance in the United States.

Although technological advances have begun to divide mobile devices into two categories, even the simplest of the mobile devices is still laden with features. For example, a “feature phone” includes mobile devices that can take pictures, play games, write text, and/or even record audio and/or video. However, these types of phones do not allow users to install software and/or utilize open platforms and the like. A “smart phone” includes mobile devices that also have integrated personal digital assistants and/or light versions of desktop operating systems along with cellular communication capabilities. These types of phones do allow users to install software and/or utilize open platforms. Thus, mobile phones have become rich, feature packed devices with multiple communication means built into small, reasonably priced mobile platforms.

However, despite these advances in technology, existing technologies still do not support simple, flexible formation of groups of people for messaging, event coordination, and/or content sharing. In physical social lives, people continually come together in informal groups to exchange photos, attend events, discuss topics, and the like, yet no conventional technology supports this evolving, informal group dynamic. People are social by nature and generally prefer to participate in activities with other people. Thus, it is a basic need to seek others who have a common association or bond to share in the activity. The activity can be a simple hike through the woods with others who like to hike or a family outing to a local park for a barbecue dinner. Oftentimes conferences are held on various subjects and draw together people interested in a specific topic. Discussions and conversations between the participants soon follow and group activities form in often impromptu settings. The conference attendees may not have met prior to the conference but now would like to socialize with other participants. Unfortunately, especially in impromptu gatherings of people, technology has not afforded an easy way for these groups to coordinate activities such as dinner at a local restaurant. If plans change suddenly, it is likely some participants will be left out of the activity if they are failed to be notified individually.

In a similar fashion, people also rely on their “support” groups for socializing, information gathering, and other activities. People tend to trust others who possess a common bond. Thus, a person might trust their family members for a recommendation on a good restaurant before they would rely on a suggestion from a complete stranger. When a person is traveling, they will most often ask associates such as business contacts and the like where the good places to eat and stay can be found. This is especially true when a person ventures into unknown locations and is no longer surrounded by familiar things. They will seek out knowledge about places or locations from strangers whom they can form some kind of bond. In some situations, this can be extremely difficult—short of interviewing everyone a person sees and talking to them to see if they share anything in common or build some type of rapport. Thus, being able to easily obtain information about places and events from trusted sources is extremely valuable. It can help a weary traveler find good lodging late at night after a long drive or help a distraught teenager, standing alone outside of a dance club, find out that their friends have decided to go to another dance club at the last minute because the first club had poor music that night.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

Systems and methods are provided for associating metadata with a particular location for distribution via an associated user network. Annotated location data is leveraged to provide network participants possessing a common bond with “trusted” information regarding specific locations. This allows a network participant to locate resources such as friends, restaurants, hotels, and/or entertainment sites and the like based on the annotations provided by other network participants for those locations. Network users can annotate locations with temporal information, text, audio/video, photos, and/or graphics and the like. The annotations can be provided to the network via mobile devices such as, for example, cell phones, personal digital assistants and the like and/or via non-mobile devices such as, for example, desktop computers and the like. Annotation information can be entered before a user visits a location, while a user is visiting a particular location, and/or after a user has visited a location. Location coordinates can be automatically provided such as, for example, via global positioning systems (GPS), radio tower triangulation, mapping location service, Wi-Fi access point triangulation, and/or cell phone cell triangulation and the like. The location can also be manually entered, for example, as an address, a city, a state, a zip code, and/or a general location such as, for example, the northwest area, the east coast, the flatlands, and/or the desert and the like.

The annotations are correlated with the locations and provided to an associated user network. The network then selectively provides the annotated information to groups within the network. The annotation retrieval can occur automatically such as, for example, while a network participant is moving from location to location (e.g., utilizing a mobile device with GPS and/or mapping software, etc.) and/or retrieved “on demand” as specified by the network participant and the like. This allows a user to review location annotation information before they travel to a location and/or, for example, to review where other participants have been over a period of time and the like. Thus, the networked annotation data provides a powerful tool with substantial flexibility to easily provide trusted location annotations that can facilitate both social and business related tasks and the like.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of a location annotation system in accordance with an aspect of an embodiment.

FIG. 2 is another block diagram of a location annotation system in accordance with an aspect of an embodiment.

FIG. 3 is yet another block diagram of a location annotation system in accordance with an aspect of an embodiment.

FIG. 4 is still yet another block diagram of a location annotation system in accordance with an aspect of an embodiment.

FIG. 5 is still yet another block diagram of a location annotation system in accordance with an aspect of an embodiment.

FIG. 6 is an illustration of a system architecture for facilitating location annotation in accordance with an aspect of an embodiment.

FIG. 7 is a flow diagram of a method of facilitating location annotation in accordance with an aspect of an embodiment.

FIG. 8 is another flow diagram of a method of facilitating location annotation in accordance with an aspect of an embodiment.

FIG. 9 is yet another flow diagram of a method of facilitating location annotation in accordance with an aspect of an embodiment.

FIG. 10 illustrates an example operating environment in which an embodiment can function.

FIG. 11 illustrates another example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

The subject matter provides systems and methods for tagging physical locations and sharing the tag information with a selected group. Location annotating or “tagging” allows for associating digital text and/or media with a physical location (i.e., tagging is tying a user annotation to a specific location). Event type tagging is a specialized tag where an annotation is associated with a location and time combination (e.g., a yearly music festival). Digital content such as, for example, a comment is entered as a digital tag into, for example, a mobile device that can be aware of its physical location coordinates and, for example, is then sent to a server for later distribution to other participants of the group. Tags entered by other people in groups to which the user belongs can be leveraged to simplify tag entry and enhance the value of location tagging by providing the user with tags from people they know or “trust” within the context of a group. The annotation information can be easily disseminated to participants of the group via, for example, a web service. For example, this also allows participants to let others know their location and/or to easily locate their friends. Location tagging provides information that is relevant/scoped to the user, not only because of where the user is and who the user's groups are, but when the user is there.

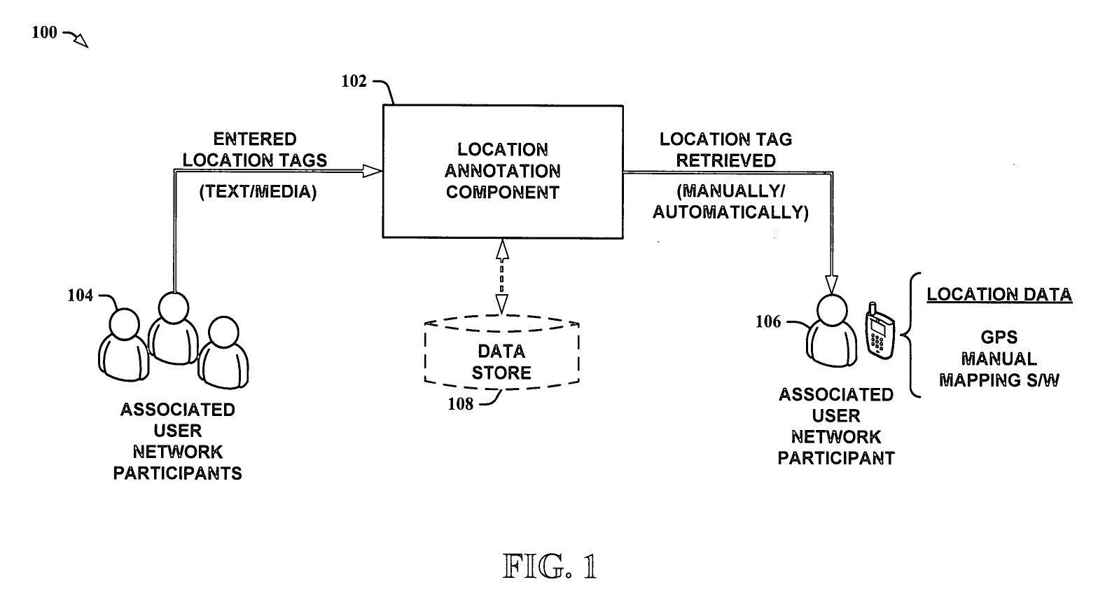

In FIG. 1, a block diagram of a location annotation system 100 in accordance with an aspect of an embodiment is shown. The location annotation system 100 is comprised of a location annotation component 102 that interfaces with associated user network participants 104 and an associated user network participant 106. The location annotation component 102 can also interface with an optional data store 108. The associated user network participants 104 belong to an “associated user” network—which is a network of groups of users that share a common association or bond. The bond can be strong such as in a social group and/or a family group. The bond can also be weak such as when the only association between users is that they joined a particular group just for the association alone (e.g., to obtain advice or information about a topic from knowledgeable users). A user can also join a group for financial gain (e.g., to be paid for providing annotations and/or to be paid for evaluating annotations and the like). A network can also include both groups of users and/or a set of pairwise relationships from which groups can be inferred (cluster analysis, etc.). The ‘association’ generally instills a user with a higher confidence level or ‘trust’ of other users in the group. Thus, the value of information obtained from a group member is higher than information obtained from sources outside of the group. Oftentimes, users join groups solely for the value of shared information. The location annotation component 102 can increase this value by allowing the information to be readily available to other participants of the group.

The location annotation component 102 obtains location annotations or tags from the associated user network participants 104. The annotations can include, but are not limited to, temporal information, text and/or media and the like. Media can include, but is not limited to, photographs, video, audio, and/or graphics and the like. Temporal information can include, but is not limited to, time of the annotation and/or when and/or how long the annotation is valid and the like. The location annotation component 102 then associates or correlates the annotations with a location. Thus, a single location can have more than one annotation provided by a single participant and/or multiple participants of the associated user network. The location annotation component 102 can also aggregate the annotations to facilitate in deriving an annotation for a location and/or locations. For example, the associated user network participants 104 can each rate a restaurant on a scale of 1 to 10 and include that as an annotation. The location annotation component 102 can average the ratings (i.e., annotations) of the restaurant (i.e., location) and derive a new annotation for the restaurant (i.e., location) to distribute to the associated user network participant 106. Additionally, a user might want to know temporally grouped information such as, for example, recent ratings of a restaurant, or ratings from Tuesday nights, or ratings in the Fall and the like. Thus, recency relative to now can be an important prioritization criterion for query results on tags. Users can also tag and/or retrieve events (i.e., a location and time combinations) such as, for example, yearly festivals and the like.

Location coordinates can be obtained by the location annotation component 102 via wireless means such as, for example, GPS, mapping location services, radio tower triangulation, Wi-Fi access point triangulation, and/or cell phone cell triangulation and the like. Location information such as, for example, map coordinates, street addresses, zip codes, and/or geographic references can be manually entered by the associated user network participants 104 and/or obtained via other means such as, for example, database lookups and/or mapping software and the like. Thus, location information entered by the associated user network participants 104 can facilitate the location annotation component 102 in deriving the actual location for the annotation. The location itself can be very specific, for example, such as a particular street corner on the northwest side of two intersecting streets. The location can also be a vast area such as, for example, a national park, a country, and/or even a continent and the like. Thus, associated user network participants 104 can make annotations, for example, about the country Australia, the city Sydney, the site of the Sydney Opera House, and/or a particular seat in the 3^{rd} row of the Sydney Opera House. A user can also employ names for locations that can be specifically relevant and/or known to a user's network (e.g., “Shelly's house,” “the pub,” “at the park,” etc.).

The location annotation component 102 can utilize the optional data store 108 to store the location tag (correlated annotation data) for later retrieval by the associated user network participant 106. Retrieval of the information by the associated user network participant 106 can be, for example, via a mobile device, a computer, an Internet website, and/or a hard-copy manifestation of the data (e.g., a computer printout, a poster (e.g., of a map of a city with location tags from users, etc.), a flyer, a brochure, a newsletter, etc.) and the like. In another instance, the location annotation component 102 can directly distribute the correlated annotation data to the associated user network participant 106 without storing it (e.g., in a peer-to-peer network). The associated user network participant 106 can obtain the location tag manually and/or automatically. For example, the associated user network participant 106 can utilize a mobile device that employs GPS and automatically retrieve location tags (annotation data) while traveling from location to location. The associated user network participant 106 can also manually enter location information and retrieve a location tag based upon the manually entered data. Mapping software (assisted and/or unassisted by GPS), for example, can also be utilized by the associated user network participant 106 to facilitate in determining and/or selecting a location that the associated user network participant 106 is currently at and/or is interested in. The associated user network participant 106 can also formulate queries such as “where are my friends right now” to retrieve appropriate correlated annotation data from the location annotation component 102. The annotated data, in this case, can include photographs of the friends overlaid on a map which indicates their location. In a similar fashion, associated user network participants 104 can annotate their current location with “I'm here now” to proactively inform others of their current location.

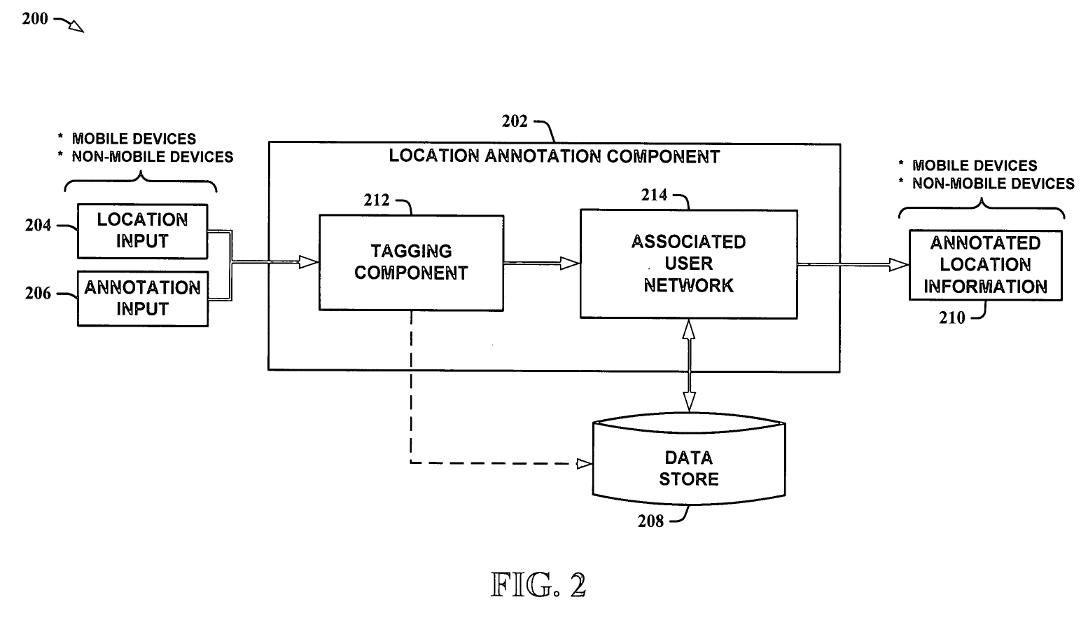

Turning to FIG. 2, another block diagram of a location annotation system 200 in accordance with an aspect of an embodiment is illustrated. The location annotation system 200 is comprised of a location annotation component 202. The location annotation component 202 is comprised of tagging component 212 and an associated user network 214. The tagging component 212 receives a location input 204 and an annotation input 206. The inputs 204, 206 can be obtained from mobile and/or non-mobile devices. The inputs 204, 206 can also be obtained from different sources and/or the same source. The tagging component 212 correlates the annotation input 206 to the location input 204 and relays the correlated data to the associated user network 214. Optionally, the tagging component 212 can store the correlated data in a data store 208. The associated user network 214 receives the correlated data and stores the data in the data store 208 and/or provides annotated location information 210 immediately. The associated user network 214 can receive the correlated data directly from the tagging component 212 and/or indirectly from the tagging component 212 via the data store 208. The annotated location information 210 can be provided to mobile and/or non-mobile devices alike. The associated user network 214 facilitates in the selective distribution of the correlated information to participants of the network. The tagging component 212 and the associated user network 214 can be physically remote from one another. The data store 208 can also be physically remote from the tagging component 212 and/or the associated user network 214.

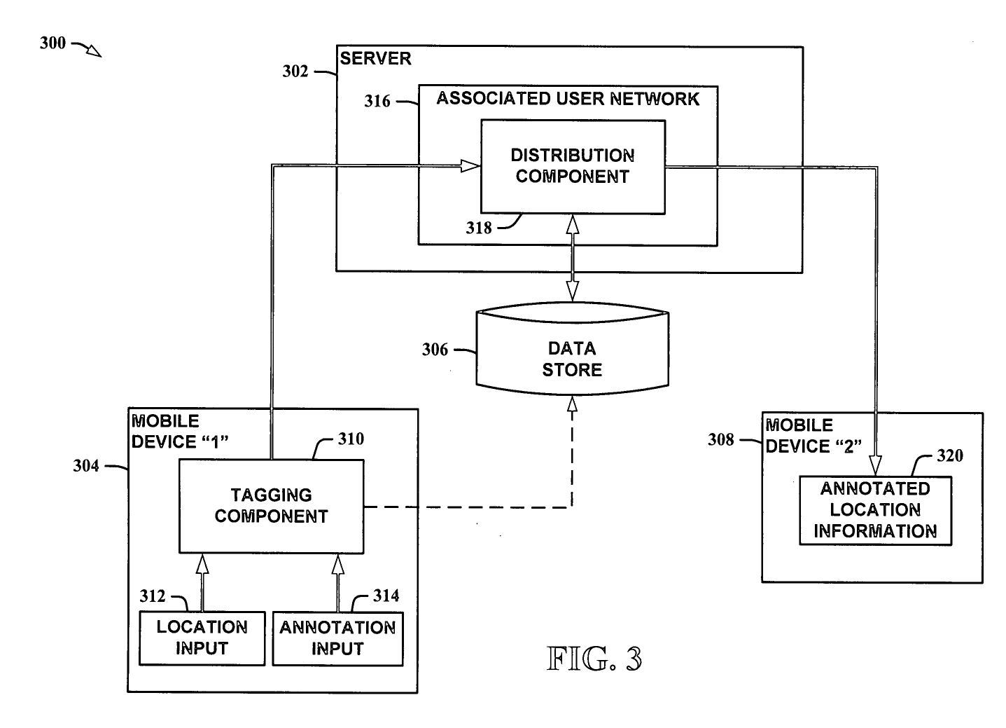

Looking at FIG. 3, yet another block diagram of a location annotation system 300 in accordance with an aspect of an embodiment is depicted. The location annotation system 300 is comprised of a server 302 that interacts with a mobile device “1” 304, a data store 306, and a mobile device “2” 308. Although only one server and two mobile devices are illustrated in this example, the location annotation system 300 can be comprised of more than one server and/or more than two mobile devices. Likewise, the data store 306 can be comprised of multiple data stores at the same and/or different locations. The mobile device “1” 304 is comprised of a tagging component 310 that receives a location input 312 and an annotation input 314. The location input 312 can be automatically (e.g., GPS, Wi-Fi signal triangulation, radio tower triangulation, cell phone cell triangulation, etc.) and/or manually obtained (e.g., mapping software, user entered, etc.) via the mobile device “1” 304. The annotation input 314 can include, but is not limited to, temporal information, text, graphics, audio, video, and/or photographs and the like. The tagging component 310 correlates the annotation input 314 to the location input 312. The tagging component 310 can then relay the correlated data to the server 302 via a communication means such as, for example, cellular communications, satellite communications, radio communications, Wi-Fi communications, and/or bluetooth communications and the like. The tagging component 310 can optionally store the correlated data directly to the data store 306.

The server 302 hosts an associated user network 316 that utilizes a distribution component 318. The associated user network 316 is a network of participants that have a common association or bond. It 316 utilizes a server such as, for example, a server that employs the Internet for communications. The distribution component 318 receives the correlated data from the tagging component 310 (directly and/or indirectly via the data store 306) and distributes the data immediately to the mobile device “2” 308 as annotated location information 320 and/or stores the correlated data in the data store 306 for distribution at a later time. The mobile device “2” 308 can obtain the annotated location information 320 automatically and/or manually via the communication means described supra.

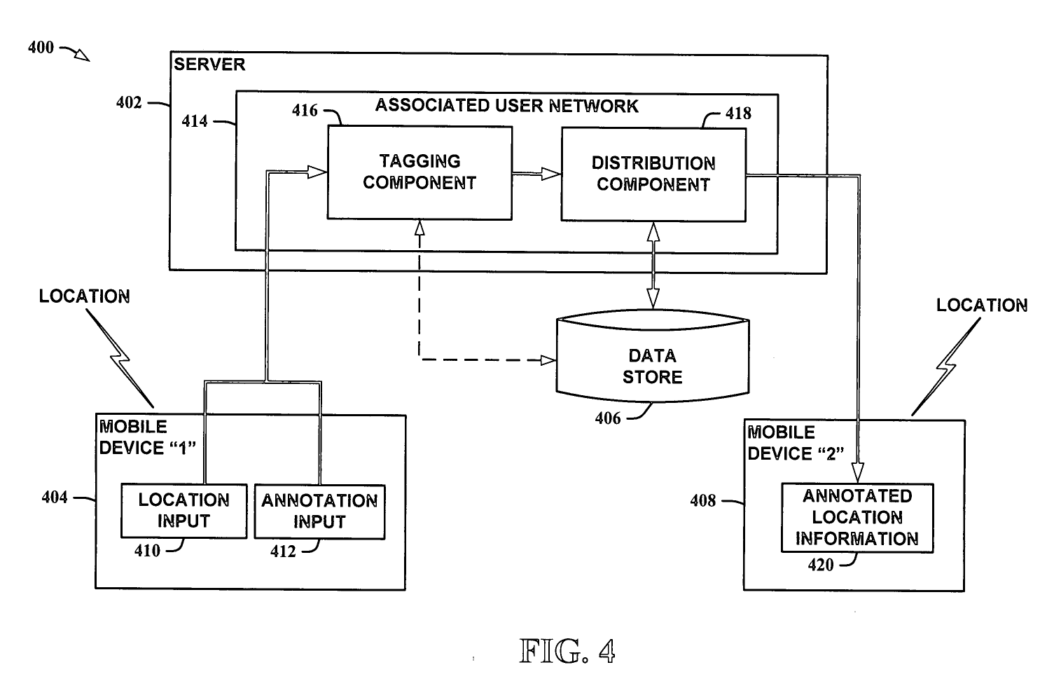

Referring to FIG. 4, still yet another block diagram of a location annotation system 400 in accordance with an aspect of an embodiment is shown. The location annotation system 400 is comprised of a server 402 that interacts with a mobile device “1” 404, a data store 406, and a mobile device “2” 408. Although only one server and two mobile devices are illustrated in this example, the location annotation system 400 can be comprised of more than one server and/or more than two mobile devices. Likewise, the data store 406 can be comprised of multiple data stores at the same and/or different locations. The mobile device “1” 404 provides a location input 410 and an annotation input 412. The location input 410 can be automatically (e.g., GPS, Wi-Fi signal triangulation, radio tower triangulation, cell phone cell triangulation, etc.) and/or manually obtained (e.g., mapping software, user entered, etc.) via the mobile device “1” 404. The annotation input 412 can include, but is not limited to, temporal information, text, graphics, audio, video, and/or photographs and the like. The mobile device “1” 404 can then relay the inputs 410, 412 to the server 402 via a communication means such as, for example, cellular communications, satellite communications, radio communications, Wi-Fi communications, and/or bluetooth communications and the like.

The server 402 hosts an associated user network 414 that is comprised of a tagging component 416 and a distribution component 418. The associated user network 414 is a network of participants that have a common association or bond. It 414 utilizes a server such as, for example, a server that employs the Internet for communications. The tagging component 416 receives the inputs 410, 412 from the mobile device “1” 404 and correlates the annotation input 412 to the location input 410. The tagging component 416 can optionally store the correlated data directly to the data store 406. The distribution component 418 receives the correlated data from the tagging component 416 (directly and/or indirectly via the data store 406) and distributes the data immediately to the mobile device “2” 408 as annotated location information 420 and/or stores the correlated data in the data store 406 for distribution at a later time. The mobile device “2” 408 can obtain the annotated location information 420 automatically and/or manually via the communication means described supra. In this manner, a centralized tagging system is employed that can facilitate to simplify enhancements to the mobile devices 404, 408 to reduce costs and/or increase utilization of legacy equipment. This also facilitates in easily updating the tagging component 416 to the benefit of all users.

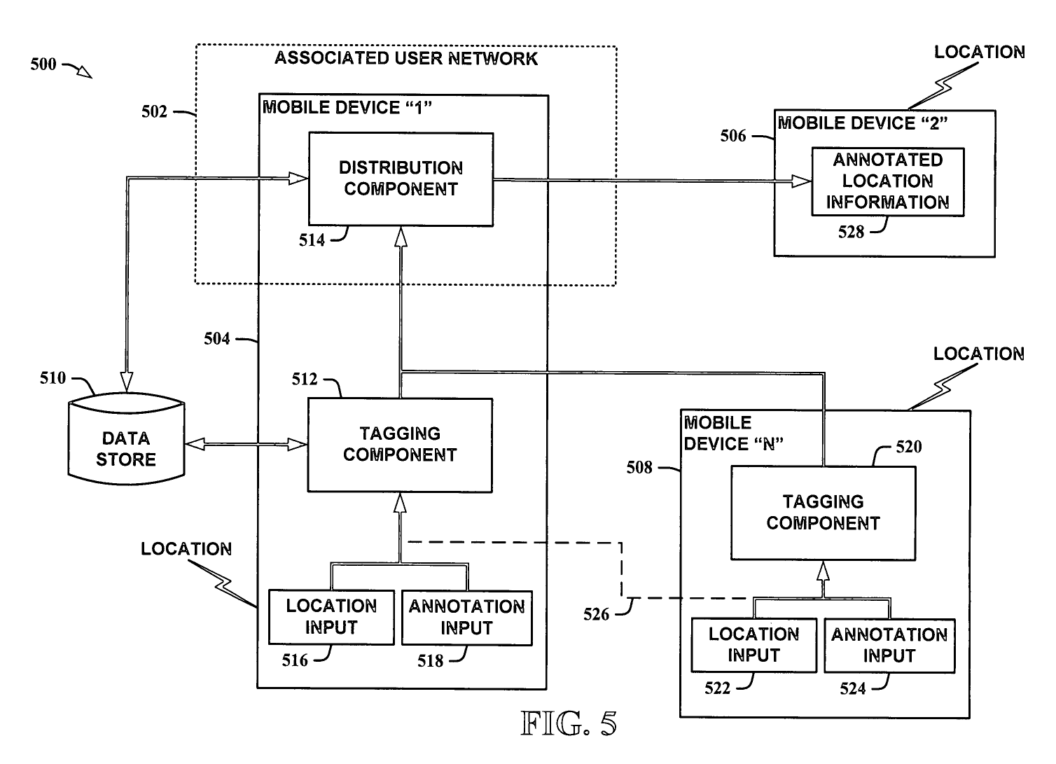

Moving on to FIG. 5, still yet another block diagram of a location annotation system 500 in accordance with an aspect of an embodiment is depicted. The location annotation system 500 is comprised of an associated user network 502 (utilizing mobile device “1” 504), a mobile device “1” 504, a mobile device “2” 506, a mobile device “N” 508, where “N” represents an integer from one to infinity, and a data store 510. Functionality of the associated user network 502 resides within the mobile device “1” 504. Thus, the mobile device “1” 504 acts as a data server for mobile device “2” 506, mobile device “N” 508, and/or itself 504. The mobile device “1” 504 is comprised of a distribution component 514 and a tagging component 512 that receives a location input 516 and an annotation input 518. The location input 516 can be automatically (e.g., GPS, Wi-Fi signal triangulation, radio tower triangulation, cell phone cell triangulation, etc.) and/or manually obtained (e.g., mapping software, user entered, etc.) via the mobile device “1” 504. The annotation input 518 can include, but is not limited to, temporal information, text, graphics, audio, video, and/or photographs and the like. The tagging component 512 correlates the annotation input 518 to the location input 516. The tagging component 512 can then relay the correlated data to the distribution component 514. The tagging component 512 can also store the correlated data directly to the data store 510. The data store 510 can reside locally to the mobile device “1” 504 and/or remotely to the mobile device “1” 504. The distribution component 514 receives the correlated data from the tagging component 512 and/or the data store 510 and distributes the data to the mobile device “2” 506 as annotated location information 528 and/or stores the correlated data in the data store 510 for distribution at a later time. The mobile device “2” 506 can obtain the annotated location information 528 automatically and/or manually via the communication means such as, for example, cellular communications, radio communications, satellite communications, Wi-Fi communications, and/or bluetooth communications and the like.

Mobile device “N” 508 represents additional mobile devices utilized by participants of the associated user network 502. Mobile device “N” 508 is comprised of a tagging component 520 that receives a location input 522 and an annotation input 524. Sources for the inputs 522, 524 are described supra. The tagging component 520 correlates the annotation input 524 to the location input 522 and relays the correlated data via a communication means (see, supra) to the distribution component 514 in mobile device “1” 504. The distribution component 514 can then store and/or relay the correlated data. In another instance, the location input 522 and the annotation input 524 can be directly relayed (represented by dashed line 526) to the tagging component 512 in mobile device “1” 504. This allows utilization of both the tagging component 512 and the distribution component 514 as the associated user network 502. In this manner, raw inputs can be sent to a single (and/or multiple) mobile devices for correlation and/or distribution.

This instance allows for the elimination of a dedicated remote server and utilizes existing communication means between mobile devices to facilitate in correlating and providing data utilizing peer-to-peer networks. By utilizing this type of system, a group of users can create their own network and/or further sub-groups without requiring additional equipment and/or communications. Thus, the network can be easily formed for temporary situations such as, for example, at a business conference where participants are typically congregated together in a general area. This promotes utilization of close proximity communications such as, for example, blue tooth technologies and/or radio technologies and the like.

The technologies described herein are in the domain of “tagging” physical locations with digital content. Thus, tagging, in this instance, implies attaching digital text and/or media to a physical location. The tagging occurs, for example, when digital content is entered into a mobile device that is aware of its physical location coordinates. The mobile device then passes the coordinates and the digital tag to a server for immediate and/or delayed distribution. For example, through a mobile device the user tags a physical location that contains a restaurant with the text “great Mexican food.” Services for doing this type of location tagging from mobile devices are very much in their infancy. There are a few research oriented systems along the lines of “digital graffiti,” but nothing commercially available. Even as these systems become more common, they face the issue that the user must enter tags into the system, a cumbersome process. However, with the systems and methods provided herein, the user can sidestep this issue by leveraging tags entered by other people in a group (e.g., social groups, etc.) to which the user belongs. This not only eases the burden on the user to enter tags on locations, but also provides the user with tags from people they know (within the context of a group) rather than from just anyone.

In an example scenario, assume a user is a member of a social group for communication and media sharing on a smartphone. Using this system on their smartphone and in conjunction with a location detection system such as GPS and/or other location services, the user is able to tag their favorite dance club with “dance club—great beats!” At this point, members of the groups to which they belong and to which they assign this tag become aware of it. Other group members can be made aware when they are in the vicinity of the location, and/or can view the tags and then be told where the locations are in relation to them. Thus, the system informs a second user of a location that is 0.5 miles away that the first user has tagged “dance club—great beats!” Users can also retrieve tags via other means such as from kiosks, electronic screens, and/or printed media and the like. For example, a restaurant might provide a kiosk for a user to retrieve the user's friends' ratings and/or pictures and the like. In a similar fashion, the restaurant can provide a user with an electronic menu that can display ratings for individual food items from groups that the user belongs to (e.g., a user might enter a password, etc. to allow rating information to be retrieved for display on the menu).

This technology allows the leveraging of social groups for relevant location tags and selective sharing of the location tags to groups within a user's social network. This provides a powerful tool for communicating with “known” people that a user desires to receive their location related information. When this is employed with mobile devices, users can easily share their “tags” on physical locations with groups of people via other the mobile devices. A tag typically consists of content that is paired with the coordinates or “positioning” of the physical location and then saved in a database. Tags are open-ended and can contain an arbitrary amount of text and/or other media. Physical locations can be global positioning coordinates and/or street addresses and the like.

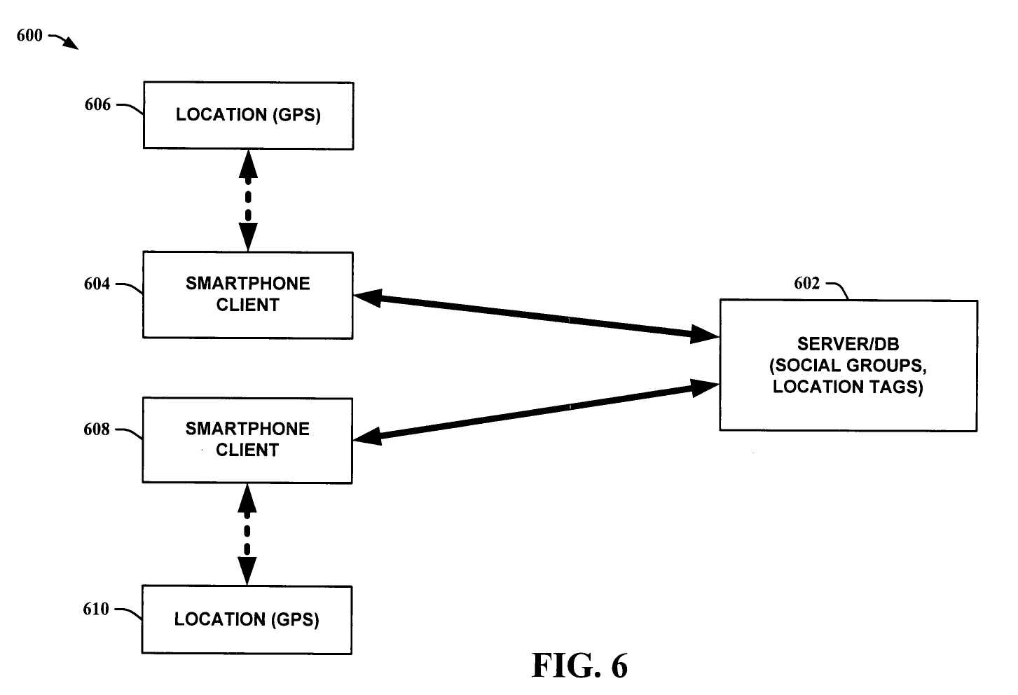

FIG. 6 is an illustration of an associated user network system architecture 600 comprised of a server/database 602 that obtains and stores network distribution information and location tags for a social network containing social groups. It 602 interfaces with a first smartphone client 604 which obtains location positioning data relating to a first location 606 using GPS. It 602 also interfaces with a second smartphone client 608 which obtains location positioning data relating to a second location 610 using GPS. In this manner location tags can be received, stored, and distributed between participants of a network utilizing mobile device technology. For example, a user can choose social groups with which to share location tags and/or receive tags from participants of specific social groups. Location detection means can include, but are not limited to, GPS, cell phone cell triangulation, radio tower triangulation, Wi-Fi access point triangulation, and/or online interactive mapping services and the like. Some of these techniques do not require additional hardware beyond a mobile device itself, saving a user from additional hardware expenses. The server/database 602 can handle, for example, social grouping, and/or saving location coordinates and tags.

The primary usage modes for network participants are adding tags and viewing tags. Typically, for ease of use, the user adds a tag to a location when at that location. Specifically, via the mobile device, the user selects “tag current location,” then enters text and/or other media (e.g., a photo and/or voice tag, etc.). An alternative is that the user can add a tag to a location while not at the location via, for example, a map interface. This is useful when giving directions and/or when entering lots of tags of known places at a single point in time. When entering a tag, the user can specify particular groups of people to whom location tags are available. For example, the user may not want their family and/or work groups to see tags they entered about the dance club. Additional metadata can also be included whenever a tag is created. For example, this additional metadata can include, but is not limited to, time of the tag, user identification, urgency of the tag, and/or group sharing data for the tag (e.g., user preferences for group sharing, default group sharing, automatic group sharing based on type of tag, etc.)

Like entering tags, a user typically views tags when in the vicinity of a physical location. In one instance, an embodiment is configurable to specify the distance from the location at which the user is to be notified of the tag. The user can be made aware of the user and/or network and/or group that originated the tag in order to provide context of the location tag. Thus, by leveraging, for example, the social network (social groups to which the user belongs), the user is provided with many location tags from known and trusted sources. Tags can also be browsed and searched while not at the physical location, enabling the user to search location tags for ‘Mexican restaurant,’ for example, in order to retrieve, for example, a) Mexican restaurants tagged by known social group members, b) any restaurant review information entered by group members into the tag, and/or c) the physical location of the restaurant.

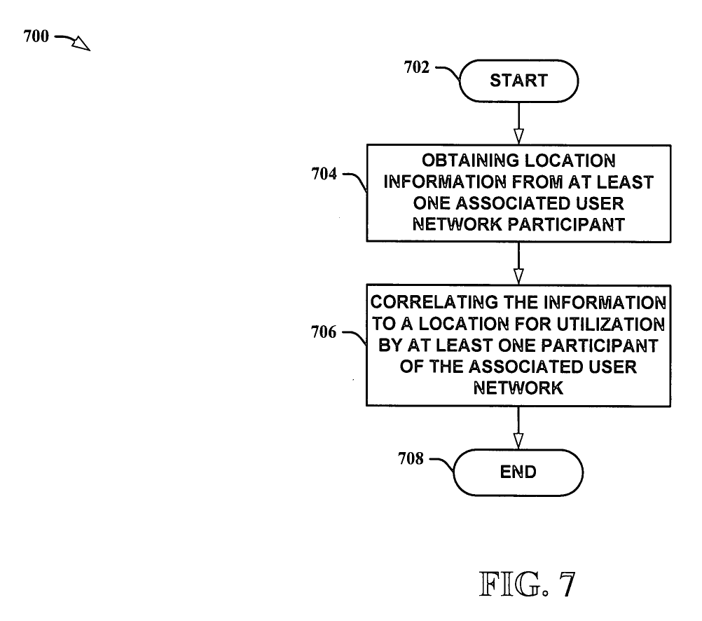

In view of the exemplary systems shown and described above, methodologies that may be implemented in accordance with the embodiments will be better appreciated with reference to the flow charts of FIGS. 7-9. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 7, a flow diagram of a method 700 of facilitating location annotation in accordance with an aspect of an embodiment is shown. The method 700 starts 702 by obtaining location information from at least one associated user network participant 704. The location information or “tag” can include, but is not limited to, text, temporal information, photos, graphics, audio, video, and/or other media and the like that relates to a location. A tag can also refer to a user's current location, which is a specialized tag in that its content can change as the user changes location (e.g., “school,” “home,” “the gym,” etc.). This type of tag is generally automatically updated as the user changes locations. The associated user network can include, but is not limited to, networks with a common association or bond such as, for example, social networks, business networks, and/or other themed networks and the like. The location information is obtained from a participant of the associated user network to facilitate in providing some assurance “trust” and/or legitimacy in the information that is obtained.

The information is then correlated to a location for utilization by at least one participant of the associated user network 706, ending the flow 708. The correlating of the information to the location allows for retrieval of tag information based on location. This facilitates, for example, to provide information to a participant as they travel from location to location and/or approach a particular location. Participants can also obtain information on demand, for example, by posing queries such as, for example, “where are my friends.” The location can be obtained via techniques that can include, but are not limited to, GPS, cell phone cell triangulation, radio tower triangulation, Wi-Fi access point triangulation, and/or online interactive mapping services and the like.

The correlated information can be distributed via an Internet web service. For example, users can log onto a web site and set preferences for groups including parameters such as, for example, who to include in the group, what types of tags are automatically associated with the group, when to allow the group to access the tags, how often the tags can be accessed, whether additional privileges are required, how important a tag is (e.g., “I'm at the hospital emergency room!”=high importance/urgent, etc.) and/or whether the group can be publicly accessed and the like. Likewise, users can, for example, set parameters relating to when they would like to receive tag information, from whom they want to receive information, what types of tags they want to receive (e.g., events, photos only, etc.), what level of tag importance to receive, and/or how frequently they want their tags updated and the like. The flexibility of the technology allows for a vast array of parameters relating to tags to be manually and/or automatically set and/or determined by a participant and/or an associated user network. Accessibility via the Internet allows for a large distribution potential that can include global distribution if so desired. The Internet can also be utilized to provide peer-to-peer networks that operate without a central authority and allow distribution of tag related information directly between users.

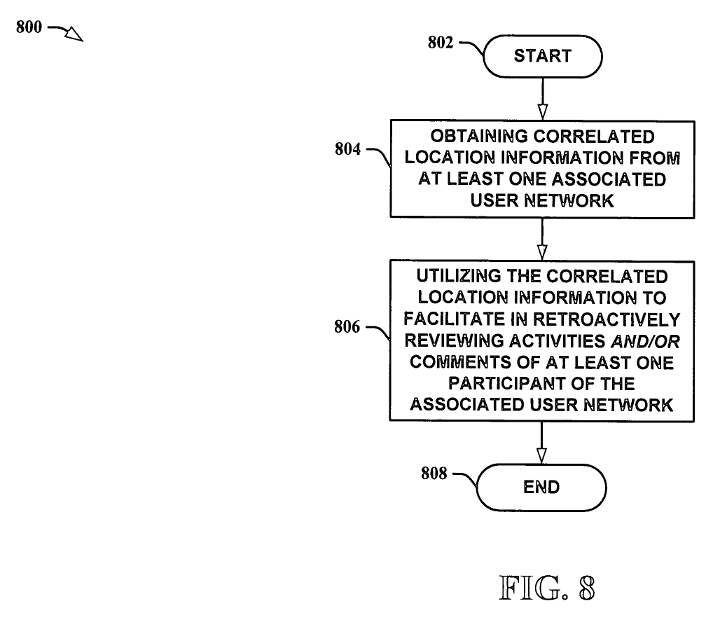

Looking at FIG. 8, another flow diagram of a method 800 of facilitating location annotation in accordance with an aspect of an embodiment is depicted. The method 800 starts 802 by obtaining correlated location information from at least one associated user network 804. The location information or “tag” can include, but is not limited to, temporal information, photos, graphics, audio, video, and/or other media and the like that relates to a location. The associated user network can include, but is not limited to, networks with a common association or bond such as, for example, social networks, business networks, and/or other themed networks and the like. The location information is obtained from a participant of the associated user network to facilitate in providing some assurance “trust” and/or legitimacy in the information that is obtained.

The correlated location information is then utilized to facilitate in retroactively reviewing activities and/or comments of at least one participant of the associated user network 806, ending the flow 808. The location tags can be recalled at a later point in time to allow a user to review location tags associated with a particular user (e.g., tracking a user's travels and/or activities for a specific date and the like) and/or a particular location (e.g., reviewing all comments for a particular location to see what all participants of a group had to say about the location). A review period can extend over any length of time from, for example, a few minutes, to days, to weeks, to months and even to years. The period of time being reviewed can be from any time in the past, for example, from a week ago or from 10 years ago. This allows a nostalgic “trip” back in time to see what a group was thinking at that time and place.

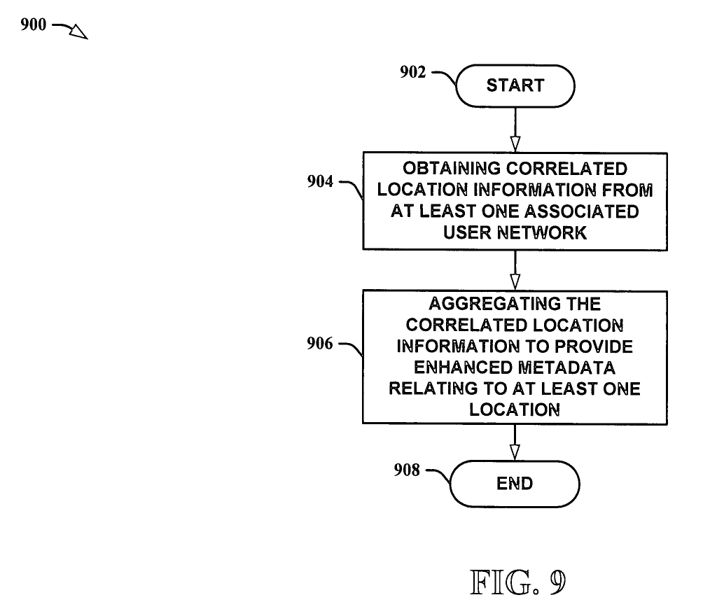

Turning to FIG. 9, yet another flow diagram of a method 900 of facilitating annotation recognition in accordance with an aspect of an embodiment is illustrated. The method 900 starts 902 by obtaining correlated location information from at least one associated user network 904. The correlated location information can include location information or “tag” such as, for example, temporal information, photos, graphics, audio, video, and/or other media and the like and an associated location. The associated user network can include, but is not limited to, networks with a common association or bond such as, for example, social networks, business networks, and/or other themed networks and the like. The correlated location information utilizes information obtained from a participant of the associated user network to facilitate in providing some assurance “trust” and/or legitimacy in the information that is obtained.

The correlated location information is then aggregated to provide enhanced metadata relating to at least one location 906, ending the flow 908. The correlated location information can be aggregated utilizing techniques, for example, that employ averages, means, overlays (e.g., composite images, etc.), extrapolations, compilations, and/or final values (e.g., “which location is the best”) and the like. If participants of a group rate a particular restaurant location on a scale of 1 to 10, the average value of the participants' ratings can be provided to another participant of the group instead of and/or with the individual ratings. In a similar fashion, if multiple participants “tag” a location with a photograph, the images can be overlaid and/or compiled to provide a more complete photograph and/or three-dimensional image of the location and the like (e.g., combine a south view with a southeast view and a southwest view to give a panoramic view, etc.). One skilled in the art can appreciate the vast array of techniques that can be applied to aggregate the location information, especially given that the type of information tagged to a location can include temporal information, text, and/or media and the like. The aggregation of the tagging information can substantially enhance the value of the location information. A mobile device user typically has limited bandwidth to review a large amount of data on the device itself and through aggregation more information can be relayed to the user in a shorter amount of time (e.g., color encoded symbols that indicate whether cumulatively a restaurant location is rated “excellent,” “good,” or “bad”).

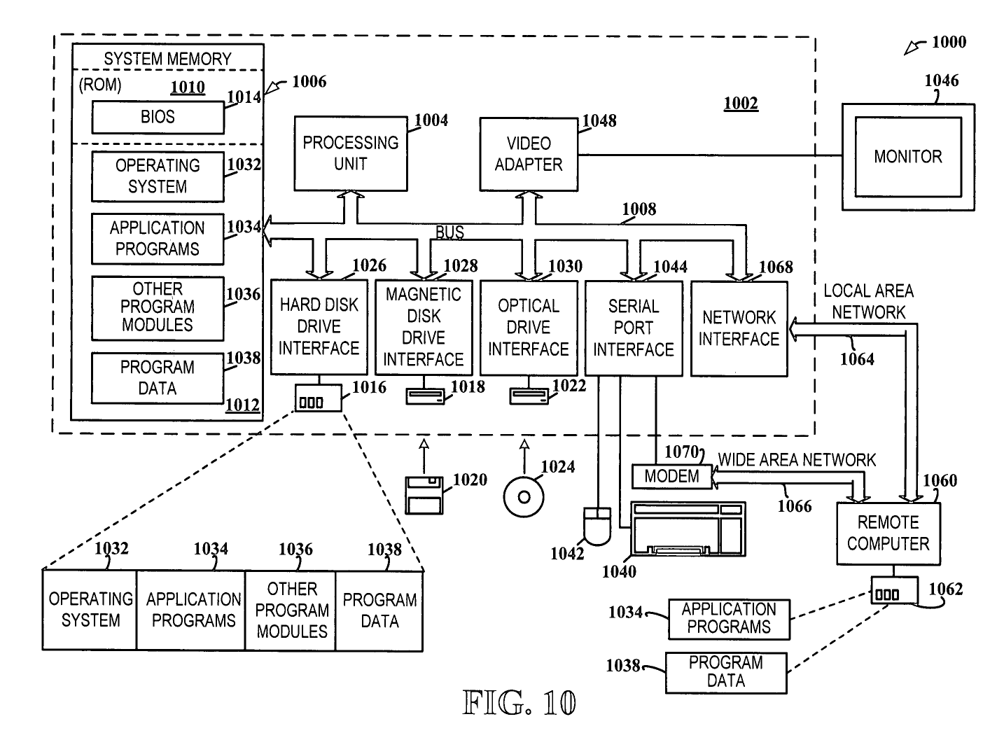

In order to provide additional context for implementing various aspects of the embodiments, FIG. 10 and the following discussion is intended to provide a brief, general description of a suitable computing environment 1000 in which the various aspects of the embodiments may be implemented. While the embodiments have been described above in the general context of computer-executable instructions of a computer program that runs on a local computer and/or remote computer, those skilled in the art will recognize that the embodiments may also be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the embodiments may also be practiced in distributed computing environments where certain tasks are performed by remote processing devices that are linked through a communications network. However, some, if not all, aspects of the embodiments may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 10, an exemplary system environment 1000 for implementing the various aspects of the embodiments include a conventional computer 1002, including a processing unit 1004, a system memory 1006, and a system bus 1008 that couples various system components, including the system memory, to the processing unit 1004. The processing unit 1004 may be any commercially available or proprietary processor. In addition, the processing unit may be implemented as multi-processor formed of more than one processor, such as may be connected in parallel.

The system bus 1008 may be any of several types of bus structure including a memory bus or memory controller, a peripheral bus, and a local bus using any of a variety of conventional bus architectures such as PCI, VESA, Microchannel, ISA, and EISA, to name a few. The system memory 1006 includes read only memory (ROM) 1010 and random access memory (RAM) 1012. A basic input/output system (BIOS) 1014, containing the basic routines that help to transfer information between elements within the computer 1002, such as during start-up, is stored in ROM 1010.

The computer 1002 also may include, for example, a hard disk drive 1016, a magnetic disk drive 1018, e.g., to read from or write to a removable disk 1020, and an optical disk drive 1022, e.g., for reading from or writing to a CD-ROM disk 1024 or other optical media. The hard disk drive 1016, magnetic disk drive 1018, and optical disk drive 1022 are connected to the system bus 1008 by a hard disk drive interface 1026, a magnetic disk drive interface 1028, and an optical drive interface 1030, respectively. The drives 1016-1022 and their associated computer-readable media provide nonvolatile storage of data, data structures, computer-executable instructions, etc. for the computer 1002. Although the description of computer-readable media above refers to a hard disk, a removable magnetic disk and a CD, it should be appreciated by those skilled in the art that other types of media which are readable by a computer, such as magnetic cassettes, flash memory, digital video disks, Bernoulli cartridges, and the like, can also be used in the exemplary operating environment 1000, and further that any such media may contain computer-executable instructions for performing the methods of the embodiments.

A number of program modules may be stored in the drives 1016-1022 and RAM 1012, including an operating system 1032, one or more application programs 1034, other program modules 1036, and program data 1038. The operating system 1032 may be any suitable operating system or combination of operating systems. By way of example, the application programs 1034 and program modules 1036 can include a location annotation scheme in accordance with an aspect of an embodiment.

A user can enter commands and information into the computer 1002 through one or more user input devices, such as a keyboard 1040 and a pointing device (e.g., a mouse 1042). Other input devices (not shown) may include a microphone, a joystick, a game pad, a satellite dish, a wireless remote, a scanner, or the like. These and other input devices are often connected to the processing unit 1004 through a serial port interface 1044 that is coupled to the system bus 1008, but may be connected by other interfaces, such as a parallel port, a game port or a universal serial bus (USB). A monitor 1046 or other type of display device is also connected to the system bus 1008 via an interface, such as a video adapter 1048. In addition to the monitor 1046, the computer 1002 may include other peripheral output devices (not shown), such as speakers, printers, etc.

It is to be appreciated that the computer 1002 can operate in a networked environment using logical connections to one or more remote computers 1060. The remote computer 1060 may be a workstation, a server computer, a router, a peer device or other common network node, and typically includes many or all of the elements described relative to the computer 1002, although for purposes of brevity, only a memory storage device 1062 is illustrated in FIG. 10. The logical connections depicted in FIG. 10 can include a local area network (LAN) 1064 and a wide area network (WAN) 1066. Such networking environments are commonplace in offices, enterprise-wide computer networks, intranets and the Internet.

When used in a LAN networking environment, for example, the computer 1002 is connected to the local network 1064 through a network interface or adapter 1068. When used in a WAN networking environment, the computer 1002 typically includes a modem (e.g., telephone, DSL, cable, etc.) 1070, or is connected to a communications server on the LAN, or has other means for establishing communications over the WAN 1066, such as the Internet. The modem 1070, which can be internal or external relative to the computer 1002, is connected to the system bus 1008 via the serial port interface 1044. In a networked environment, program modules (including application programs 1034) and/or program data 1038 can be stored in the remote memory storage device 1062. It will be appreciated that the network connections shown are exemplary and other means (e.g., wired or wireless) of establishing a communications link between the computers 1002 and 1060 can be used when carrying out an aspect of an embodiment.

In accordance with the practices of persons skilled in the art of computer programming, the embodiments have been described with reference to acts and symbolic representations of operations that are performed by a computer, such as the computer 1002 or remote computer 1060, unless otherwise indicated. Such acts and operations are sometimes referred to as being computer-executed. It will be appreciated that the acts and symbolically represented operations include the manipulation by the processing unit 1004 of electrical signals representing data bits which causes a resulting transformation or reduction of the electrical signal representation, and the maintenance of data bits at memory locations in the memory system (including the system memory 1006, hard drive 1016, floppy disks 1020, CD-ROM 1024, and remote memory 1062) to thereby reconfigure or otherwise alter the computer system's operation, as well as other processing of signals. The memory locations where such data bits are maintained are physical locations that have particular electrical, magnetic, or optical properties corresponding to the data bits.

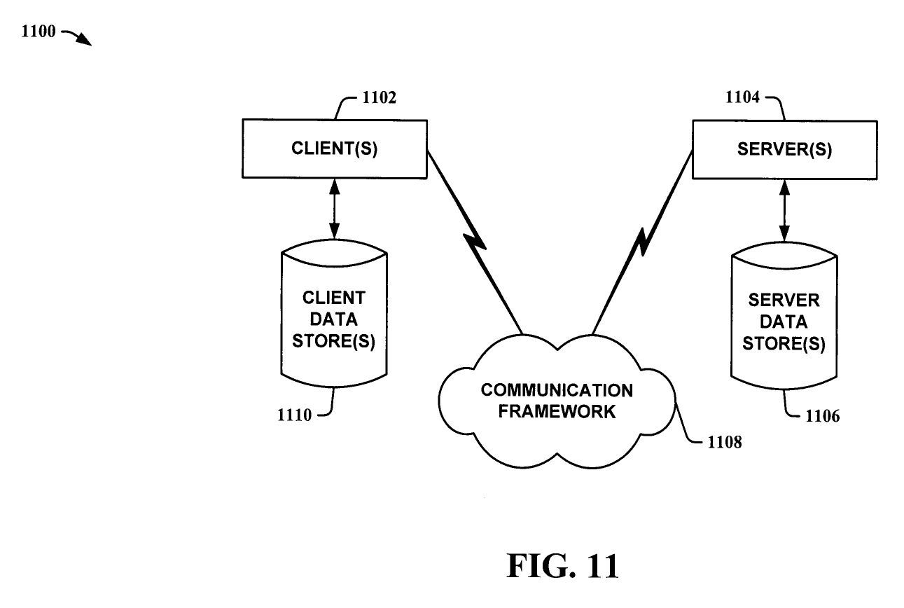

FIG. 11 is another block diagram of a sample computing environment 1100 with which embodiments can interact. The system 1100 further illustrates a system that includes one or more client(s) 1102. The client(s) 1102 can be hardware and/or software (e.g., threads, processes, computing devices). The system 1100 also includes one or more server(s) 1104. The server(s) 1104 can also be hardware and/or software (e.g., threads, processes, computing devices). One possible communication between a client 1102 and a server 1104 may be in the form of a data packet adapted to be transmitted between two or more computer processes. The system 1100 includes a communication framework 1108 that can be employed to facilitate communications between the client(s) 1102 and the server(s) 1104. The client(s) 1102 are connected to one or more client data store(s) 1110 that can be employed to store information local to the client(s) 1102. Similarly, the server(s) 1104 are connected to one or more server data store(s) 1106 that can be employed to store information local to the server(s) 1104.

It is to be appreciated that the systems and/or methods of the embodiments can be utilized in location annotation facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that correlates information, comprising:
a tagging component that obtains information relating to a physical location from a participant of an associated user network and correlates the information with the physical location; and
a distribution component that obtains the correlated information from the tagging component and provides the correlated information to at least one participant of the associated user network.

2. The system of claim 1, the associated user network comprising a social network that provides location information to at least one participant of at least one group of the social network.

3. The system of claim 2, the distribution component selectively shares the location information to groups within a participant's social network.

4. The system of claim 1, the associated user network is a private and/or public network.

5. The system of claim 1, the distribution component provides the location information to at least one network participant via a mobile device, a computer, an Internet website, and/or a hard-copy manifestation of the data.

6. The system of claim 1, the distribution component provides location information obtained from a network participant during a visit to a location, after a visit to a location, before a visit to a location, and/or without a visit to a location.

7. The system of claim 1, the distribution component stores the location correlated information in a database to allow subsequent retrieval and distribution.

8. The system of claim 1, the distribution component provides the correlated information to a participant in response to a query pertaining to participants of a group of the associated user network.

9. The system of claim 1, distribution component and/or tagging component resides on a remote server, a local server, a mobile device, and/or a computer.

10. The system of claim 1, the tagging component stores the location correlated information in a database for access by the distribution component, the database resides on a remote server, a local server, a mobile device, and/or a computer.

11. The system of claim 1, the location information including, at least in part, temporal information relating to the location.

12. The system of claim 1, the location information comprising text, images, and/or video.

13. A mobile device that employs the system of claim 1 to allow a user to remotely input and/or obtain information pertaining to a location.

14. A mobile device that utilizes the system of claim 1 to provide location-specific information to a participant based on the participant's current location.

15. The system of claim 1, the location automatically determined by a mobile device when the location information is created by a participant.

16. A method for facilitating information correlation, comprising:
obtaining information from at least one associated user network participant, the information relating to at least one physical location; and
correlating the information to the physical location for utilization by at least one participant of the associated user network.

17. The method of claim 16 further comprising:
selectively distributing the correlated information via an Internet web service.

18. The method of claim 16 further comprising:
utilizing the correlated information to facilitate in retroactively reviewing the activities and/or comments of at least one participant of the associated user network.

19. The method of claim 16 further comprising:
aggregating the correlated information to provide enhanced metadata relating to at least one location.

20. A system that facilitates information correlation, comprising:
means for obtaining information relating to a physical location from a participant of an associated user network;
means for correlating the information with the physical location; and
means for selectively distributing the correlated information to at least one participant of the associated user network.
